(19) United States
(12) Patent Application Publication
(10) Pub. No.: US 2022/0415211 A1
(43) Pub. Date: Dec. 29, 2022

(54) PROTECTIVE CASE FOR GRADED CARDS

(71) Applicant: Phillip Taylor, Lithia, FL (US)

(72) Inventor: Phillip Taylor, Lithia, FL (US)

(21) Appl. No.: 17/304,757

(22) Filed: Jun. 25, 2021

(51) Int. Cl. G09F 1/12; A45C 11/18; A45C 13/00

(52) U.S. Cl. CPC G09F 1/12; A45C 11/18; A45C 13/002

(57) ABSTRACT

A card slab case for protecting graded card slabs while still facilitating the visibility of the trading card and the grade card is provided. The card slab case has separable front and rear case portions, each with an outer border, one outer border having a recessed groove and the other outer border having a raised lip. As a result, when two card slab cases coextensively interface, the groove and complementary lip operatively nest, thereby enabling a stacked configuration preventing the two adjacent card slab cases from sliding relative to each other.

### BACKGROUND OF THE INVENTION

The present invention relates to graded trading cards and, more particularly, a protective case for graded cards, wherein the protective case is adapted to snap-fit together around an existing graded card slab, thereby facilitating a stacked configuration that protects and conveniently arranges a plurality of graded card slabs.

Card grading is the practice of submitting a trading card to a third-party service, who are authorized or otherwise credentialled to inspect the trading card for authenticity as well as rank, usually on a 10-point scale, the condition of the card. The card is then assigned an overall grade, sealed in a tamper-proof holder and, finally, assigned a cataloged serial number.

The identification information, the rank, the grade, the serial number and the like are noted on a ‘grade card’ that is physically associated to the trading card by way of a card slab. The card slab is a planar frame having a trading card portion and a grade card portion, which in turn are dimensioned and adapted to accommodate, support and circumscribe the trading card and the trading card's grade card, respectively. Each of these two portions typically have a front and rear window making the respective trading card and grade card visible from the front and the rear views of the card slab, while fully encapsulating the valuable trading card and grade card.

The benefits of card grading include proof of authenticity and attestation of quality, and as a result an increase in value of the card when compared to an ungraded card in an equal or similar condition. Accordingly, for collectors, graded trading cards are important. Furthermore, the trading card and the associated graded card encased in the unitary card slab can enhance the aesthetics and/or the commanding presence when displaying the trading card.

There are several options for storing and displaying graded cards. The size of an encapsulated graded card (in the card slab) requires specially sized boxes. These boxes vary from simple corrugated cardboard boxes all the way up to elaborate wood and velvet-lined archival boxes. However, current systems may not secure graded card slabs sufficiently enough to preventing the graded card slabs from sliding into each other. And it is well known that card slabs/capsules are prone to scratching. While this does not impact the card's grade and subsequent value of the card itself, it certainly diminishes its eye appeal.

As can be seen, there is a need for a protective case for graded trading cards that snaps together around existing graded card slab and facilitates securely storing a plurality of graded card slabs in a stacked configuration in such a way that adjacent graded card slabs do not slide relative to each other. In sum, the protective case prevents damage to graded card slabs and adds aesthetic appeal.

### SUMMARY OF THE INVENTION

In one aspect of the present invention, a graded card slab case includes the following: two case portions movable between an open condition and a closed condition encapsulating a grade card slab; each case portion having an outer border; a recessed groove along one outer border of the two case portions; and a raised lip along the other outer border of the two case portions, wherein the recessed groove is at least coextensive with the raised lip in such a way that the raised lip is movable into a nested condition within the recessed groove.

In another aspect of the present invention, the graded card slab case, wherein each outer border defines a central open area having a card window and a grading window, wherein each card window and each grading window is dimensioned and to be at least coextensive with a card and a grade card, respectively, of the grade card slab, wherein each case portion has a bridge portion separating the card window and the grading window, wherein the raised lip is continuous and circumscribed the central open area, and wherein the card window has a card height approximately four times of a grading height of the grading window.

In yet another aspect of the present invention, a method of storing a plurality of graded card slabs includes encasing each of the plurality of graded card slabs in the above-mentioned graded card slab case; and moving each graded card slab case into a nested condition with an adjacent graded card slab case in such a way that the graded card slabs cases of claim 1 define a stacked configuration.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a front elevation view of an exemplary embodiment of the present invention;

FIG. 3 is an exploded perspective view of an exemplary embodiment of the present invention;

FIG. 4 is a section view of an exemplary embodiment of the present invention, taken along line 4-4 in FIG. 1; and

FIG. 5 is a section view of an exemplary embodiment of the present invention, taken along line 5-5 in FIG. 1; and

FIG. 6 is a section view similar to FIG. 4, though showing a plurality of the present invention in a stacked configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

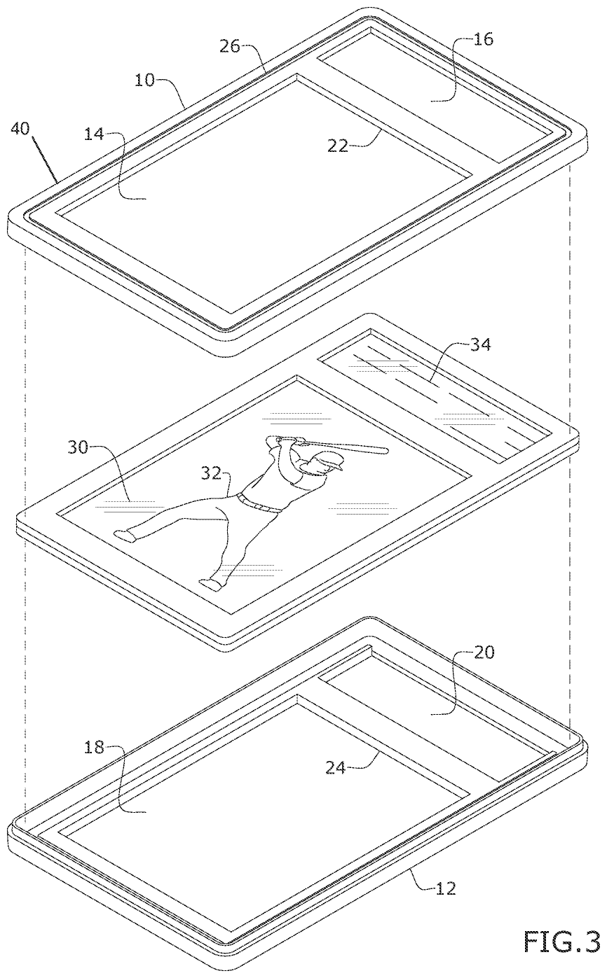

It should be understood by those skilled in the art that the use of directional terms such as front rear, and the like are used in relation to the illustrative embodiments as they are depicted in the figures. Specifically, the front direction is toward the top margin of FIG. 3, while the rear direction being toward the bottom of FIG. 3.

Broadly, an embodiment of the present invention provides a card slab case for protecting graded card slabs while still facilitating the visibility of the trading card and the grade card. The card slab case has separable front and rear case portions, each with an outer border, one outer border having a recessed groove and the other outer border having a raised lip. As a result, when two card slab cases coextensively interface, the groove and complementary lip operatively nest, thereby enabling a stacked configuration preventing the two adjacent card slab cases from sliding relative to each other.

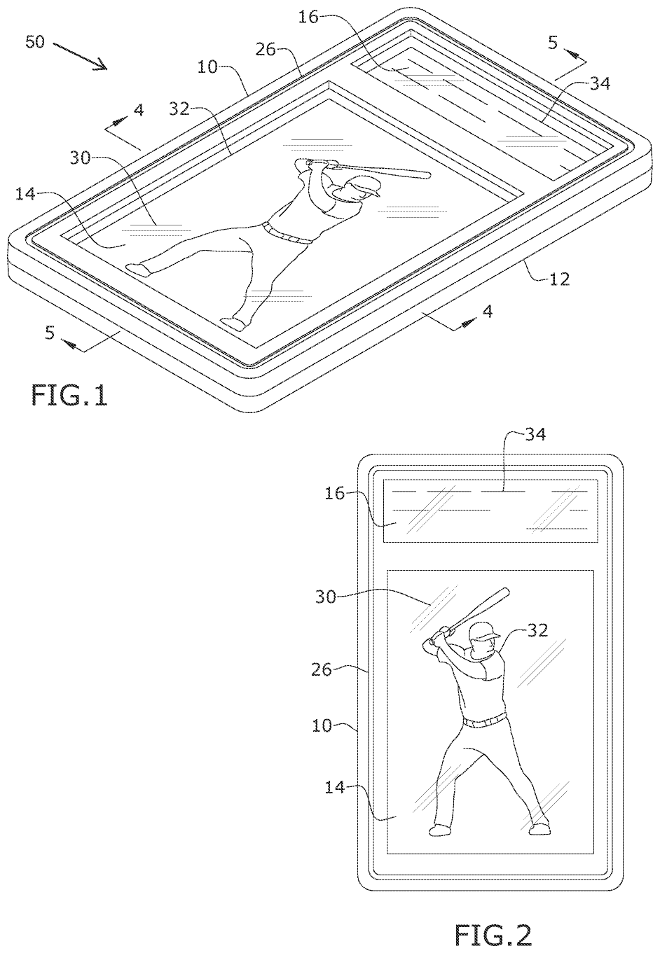

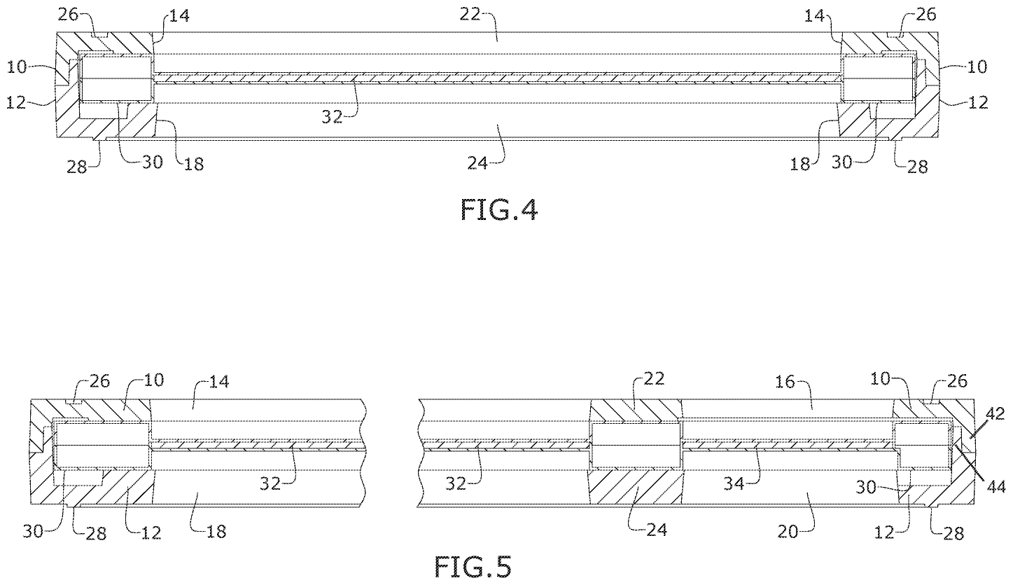

Referring now to FIGS. 1 through 6, the present invention may include a card slab case 50. The card slab case 50 may include separable a front case portion 10 and a rear case portion 12, each dimensioned and adapted to encapsulate a grade card slab 30. Each case portion 10 and 12 provides an outer (e.g., rectangular) border 40 having a central open area.

The front case portion 10 provides a front card window 14 and front grading window 16 in its central open area. Each window 14 and 16 may be made of transparent material dimensioned and adapted to be at least coextensive with the card 32 and the grade card 34 of the grade card slab 30, respectively, so that a front of the card 32 and a front of the grade card 34 are visible after encapsulation. The rear case portion 12 may provide a rear card window 18 and rear grading window 20 in its central open area, wherein each window 12 and 18 is made of transparent material dimensioned and adapted to be at least coextensive with the card 32 and the grade card 34 of the grade card slab 30 so that a rear of the card 32 and a rear of the grade card 34 are visible after encapsulation.

Each case portions 10 and 12 may have a bridge portion 22 and 24, respectively, separates the card windows (14 and18) from their respective grading window (16 and 20) and interconnecting the longitudinal elements of the outer border 40 (thereby being parallel with the end elements of the outer border 40. The card windows (14 and18) may be dimensioned to make visible a trading card 30 having dimensions of 2.5 by 3.5 inches. In other embodiments, the card windows (14 and18) may be more or less than a 2.5-inch width by a 3.5-inch height. The grading window (16 and 20) may have a width approximately equal to that of the card window (14 and 18), with a grading window (16 and 20) height approximately a third to a fourth of the card window (14 and 18) height. As used in this application, the term “about” or “approximately” refers to a range of values within plus or minus 10% of the specified number. It being understood that widths and heights can vary to accommodate different trading cards 30.

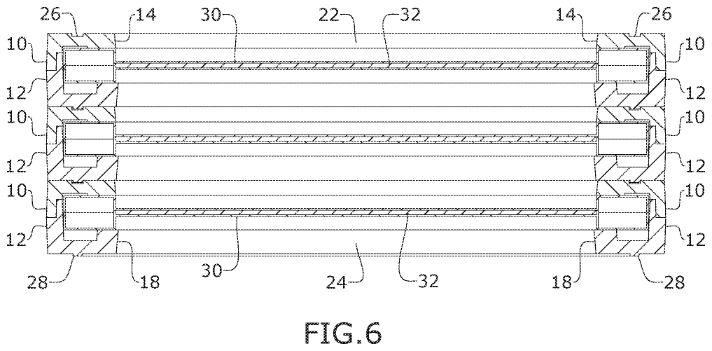

The outer border 40 of one of the two case portions 10 or 12 provides recessed groove 26, while the outer border 40 of the other of the two case portions 10 or 12 provides a raised lip 28, wherein the recessed groove and the raised lip 28 align. The recessed groove and the raised lip 28 may be continuous or discontinuous, and they are dimensioned and adapted to nest when the outer face of each of the two case portions 10 and 12 interface in a coextensive manner. For instance, when the front case portion 10 of a first card slab case 50 is stacked on the rear case portion 12 of an adjacent card slab case 50 in a stacked configuration, as illustrated in FIG. 6. Thereby, when a user is storing a plurality of graded card slabs in a stacked configuration adjacent graded card slabs to not slide relative to each other, preventing scratches and cracks to either the card slab case 50 or the graded card slab 30. The depth and protruding height of the recessed groove 26 and the raised lip 28, respectively may be approximately 1/64 to 1/16^{th} of an inch.

The case portions 10 and 12 are dimensioned and adapted to snap together around the graded card slab 30 by way of mating flanges 42 and 44, as illustrated in FIG. 5. The case portions 10 and 12 create a protective case 50 which also provides an excellent presentation to show off any graded card collection.

It should be understood, of course, that the foregoing relates to exemplary embodiments of the invention and that modifications may be made without departing from the spirit and scope of the invention as set forth in the following claims.

What is claimed is:

1. A graded card slab case, comprising:
two case portions movable between an open condition and a closed condition encapsulating a grade card slab;
each case portion having an outer border;
a recessed groove along one outer border of the two case portions; and
a raised lip along the other outer border of the two case portions, wherein the recessed groove is at least coextensive with the raised lip in such a way that the raised lip is movable into a nested condition within the recessed groove.

2. The graded card slab case of claim 1, wherein each outer border defines a central open area having a card window and a grading window.

3. The graded card slab case of claim 2, wherein each card window and each grading window is dimensioned and to be at least coextensive with a card and a grade card, respectively, of the grade card slab.

4. The graded card slab case of claim 3, wherein each case portion has a bridge portion separating the card window and the grading window.

5. The graded card slab case of claim 4, wherein the raised lip is continuous and circumscribed the central open area.

6. The graded card slab case of claim 5, wherein the card window has a card height approximately four times of a grading height of the grading window.

7. A method of storing a plurality of graded card slabs, the method comprising:
encasing each of the plurality of graded card slabs in a graded card slab case of claim 1; and
moving each graded card slab case into a nested condition with an adjacent graded card slab case in such a way that the graded card slabs cases of claim 1 define a stacked configuration.
